(19) United States
(12) Patent Application Publication
(10) Pub. No.: US 2012/0185784 A1
(43) Pub. Date: Jul. 19, 2012

(54) Method Of Providing Co-browsing Functionality Within A Standard Browser

(76) Inventor: Charles Katz, San Francisco, CA (US)

(21) Appl. No.: 13/348,560

(22) Filed: Jan. 11, 2012

Related U.S. Application Data
(60) Provisional application No. 61/432,409, filed on Jan. 13, 2011.

(51) Int. Cl. G06F 3/01

(52) U.S. Cl. 715/760

(57) ABSTRACT

A system and method for interactive internet co-browsing comprising an internet web browser, web browser pages, and web server all connected by an internet connection. The co-browsing system provides a way for an individual or multiple individuals to lead an internet web co-browsing session while an individual or multiple individuals follow the internet web co-browsing session, and vice versa.

### INCORPORATION BY REFERENCE

This application claims the benefit of priority under 35 U.S.C. 119(e) to the filing date of U.S. provisional patent application No. 61/432,409 “Method of Providing Co Browsing Functionality Within a Standard. Browser” which was filed on Jan. 13, 2011, and which is incorporated herein by reference in its entirety.

### FIELD OF THE INVENTION

This invention relates generally to how people interact with the internet and more specifically to a system and method for interactive internet co-browsing using an internet web browser and web browser pages.

### BACKGROUND OF THE INVENTION

The invention provides a way for an individual or multiple individuals to lead an internet web co-browsing session while an individual or multiple individuals follow the internet web co-browsing session, and vice versa. Co-browsing is the act of more than one individual simultaneously browsing the same web pages or web content while those individuals are using applications that can view the co-browsing on different computers. While co-browsing typically involves displaying the same entire web pages or web content to the co-browsing followers, it is also possible to have the co-browsing followers see a specific subset of the entire page such as photos, hyperlinks or any other page objects that are present in the page browsed to by the co-browsing leader or leaders. Furthermore, co-browsing also includes the co-presentation of any other content that is accessible via a Uniform Resource Locator (URL) such as an audio file, video file, and/or other content available from a web server.

Traditionally, co-browsing is accomplished only if both the leader or leaders and follower or followers download and/or install and run a special full application on their respective computers. In one approach, the special application contains within it an embedded internet web browser that works in conjunction with the special application. In another approach, a special application on the leader's computer replicates the viewed content in some manner and sends the information to another application installed on the follower's computer. The need for an application to be installed by either the leader or the follower for co-browsing is inconvenient and inefficient.

Another disadvantage of the prior art is that typically co-browsing could only be effectively accomplished if all leaders and followers had a broadband internet connection with a data connection rate of 56 kilo-baud or faster.

Another disadvantage of prior art is that the page replication approach would make it possible for more than one person to see the content of a website that required a login username and password without individually authenticating each of the followers in the co-browsing session. From the perspective of the web site owner, this could mean lost revenue and unauthorized viewing of restricted web site material.

Another disadvantage of prior art is that for the page replication approach to work, all followers would need to have installed the full co-browsing application. This is a severe disadvantage in secure computing environments as well as where installation of the application is not allowed.

Another disadvantage of the prior art is that with the page replication technique, only one leader can lead a co-browsing session at any given time. This means that an interactive panel discussion using co-browsing techniques is not possible.

Another disadvantage of prior art is that with the page replication technique, the number of followers that can co-browse along with the leader is quickly restricted because of the amount of data that needs to be replicated and transmitted to the followers by the replication server can be prohibitively large.

In the present invention, co-browsing can be accomplished through the use of internet web browsers, without the need to install a separate application by either the individual or individuals leading or following the internet web co-browsing session. The present invention also avoids all the disadvantages of the prior art because it does not replicate and transmit the data.

In accordance with present invention, users may conduct a co-browsing session via any standard browser on any standard operating system, wherein both the browsers and the operation system may be across multiple platforms vis-à-vis one another. The systems and methods of accomplishing the co-browsing do not require installation of any software or application on the computer or the web browser of the users conducting the co-browsing, thus allowing the co-browsing to be accomplished more effectively and efficiently.

### OBJECTIVE OF THE INVENTION

Accordingly, it is an object of the invention to provide a system and a method for an individual or multiple individuals to lead an internet web co-browsing session while an individual or multiple individuals follow the internet web co-browsing session wherein either user can lead the other one at any given moment in time such the role of leader can change back and forth during a session.

Another object of the invention is to provide a system and a method for co-browsing that only compromises an internet web browser, web browser pages, and web server all connected by an internet connection.

Another object of the invention is to allow a user at a remote location to conduct co-browsing session and navigate the web for multiple other users without those other users having to take any action.

Another object of the invention is that either only one user can drive the browser in a passive co-browsing session, or alternatively, all of the users can drive the browser in an interactive co-browsing session.

Another object of the invention is to provide a system and a method for co-browsing that only comprises an internet web browser, instant messaging chat client, and an instant messaging web server all connected by an internet connection.

Another object of the invention is that the leaders do not need to install any application for the co-browser to function or for the leaders to lead the co-browsing session.

Another object of the invention is that the followers also do not need to install any application for the co-browser to function and for the followers to follow the co-browsing session.

Another object of the invention is that the co-browsing session can be accomplished in any standard browser; the co-browsing method works across all browser platforms including, but not limited to, Internet Explorer, Firefox, Chrome, Safari, and iOS and Android browsers.

Another objective of the invention is that the co-browsing session can be accomplished in any operating system platform, including, but not limited to, Windows operating systems, Mac operating systems, Linux operating systems, and Android operating systems.

Another objective of the invention is that the co-browsing is cross compatible with all browsers on all operating systems. For example, one user can be on Mac using Firefox, another can be on Linux using Internet Explorer, and the leader can be on Windows using Chrome, etc.

### SUMMARY OF THE INVENTION

An aspect of the invention is disclosed, specifically, a method to facilitate user to user internet co-browsing is disclosed which comprises: providing a network; provide a host computer wherein the host computer is connected to the network; having a first user connected to the network via a first web browser; having a second user connected to the network via a second web browser; the host computer is connected to the network; the host computer connects the first user to the user two; wherein the first user inputs a web URL to the host computer, the host computer automatically changes the second browser's web URL thereby causing the second user to view the content of the web URL.

In one embodiment, the first user inputs the web URL to the host computer via a message chat provided by the host computer. In one embodiment, the first user inputs the web URL to the host computer via a message chat bar within a video chat provided by the host computer. In one embodiment, the first user inputs a web url to the host computer by having the first user select a web url from a list of web urls provided by the host computer. In one embodiment, the host computer provides the list of web urls in response to the first user's request.

In one embodiment, the host computer automatically changes a sub-frame of the second browser's web URL thereby causing the second user to view the content of the web URL. In one embodiment, the second user is able to input the web URL to the host computer wherein the host computer automatically changes the first browser's web URL thereby causing the first user to view the content of the web URL.

In one embodiment, the host computer automatically changes a sub-frame of the first browser's web URL thereby causing the first user to view the content of the web URL. In one embodiment, the host computer displays in the first browser and the second browser previously displayed web URLs. In one embodiment, the host computer displays in a sub-frame of the first browser and in a sub-frame of the second browser previously displayed web URLs.

In another aspect of the invention, the system to facilitate user to user internet co-browsing comprising a network; a host computer wherein the host computer is connected to the network; a first user connected to the network via a first web browser; a second user connected to the network via a second web browser; the host computer is connected to the network; the host computer connects the first user to the second user; wherein the first user inputs a web URL to the host computer; the host computer automatically changes the second browser's web URL thereby causing the second user to view the content of the web URL.

In one embodiment, the first user inputs the web URL to the host computer via a message chat provided by the host computer. In one embodiment, the first user inputs the web URL to the host computer via a message chat bar within the video chat provided by the host computer. In one embodiment, the first user inputs a web url to the host computer by having the first user select a web url from a list of web urls provided by the host computer. In one embodiment, the host computer provides the list of web urls in response to the first user's request.

In one embodiment, the host computer automatically changes a sub-frame of the second browser's web URL thereby causing the second user to view the content of the web URL. In one embodiment, the second user is able to input the web URL to the host computer wherein the host computer automatically changes the first browser's web URL thereby causing the first user to view the content of the web URL. In one embodiment, the host computer automatically changes a sub-frame of the first browser's web URL thereby causing the first user to view the content of the web URL.

In one embodiment, the host computer displays in the first browser and the second browser previously displayed web URLs. In one embodiment, the host computer displays in a sub-frame of the first browser and in a sub-frame of the second browser previously displayed web URLs.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is view of a user conducting a video chat, co-browsing session with another user before the leader has directed the co-browsing session via URL.

FIG. 2 is a view of a user conducting a video chat, co-browsing session with another user, wherein the leader has sent a URL to the follower and the follower's iframe within the browser is transitioning to the web page according to the URL.

FIG. 3 is a view of a user conducting a video chat, co-browsing session with another user, wherein the leader has sent a URL to the follower and the follower's iframe within the browser has transitioned fully into the new web page as directed by the URL.

FIG. 4 is a schematic diagram illustrating the co-browsing session where the users are all interconnected and the leaders can direct the co-browsing session of the followers.

FIG. 5 is a schematic diagram illustrating the co-browsing session where the networks are connected and the leader can send URL which are relayed via server to the followers.

FIG. 6 is a schematic diagram illustrating the process in which the follower participates in the co-browsing session, receives URL from the leader, and views the new web page according to the URL in the iframe.

### DETAIL DESCRIPTION OF THE INVENTION

In the following description, specific details are set forth in order to provide a more thorough description of the present invention. It will be apparent, however, to one skilled in the art, that the present invention may be practice without the specific details. In other instances, well-known features have not been described in detail so as not to obscure the invention.

More specifically, the methods or arrangements of connecting the parts listed below is well-known to those with ordinary skills in website programming and/or computer programming. The creation of the follower two-frame or iframe web page is possible by someone with ordinary web page development skills.

In accordance with a preferred embodiment of the invention, there is disclosed a system and method for interactive internet co-browsing comprising an internet web browser, web browser pages, and web server all connected by an internet connection. The internet web browser used for co-browsing can be any standard browser including, but not limited to, Internet Explorer, Firefox, Opera, Safari, and Chrome. An individual leader or leaders can use any of the web browsers, an individual follower or followers can also use the same or other web browsers, and the co-browsing session can be accomplished across multiple platforms of web browsers.

Additionally, any standard operating system can be used to accomplish the co-browsing, including, but not limited to, Microsoft Windows operating systems, Mac OS operating systems, and Linux and Linux-based operating systems. More specifically, an individual leader or leaders can be using any of the operating systems, an individual follower or followers can be using the same or other web browsers, and the co-browsing session can be accomplished across multiple platforms of operating systems.

Furthermore, individual user or users can use any web browser on any operating system, and the co-browsing session can be accomplished across multiple platforms of web browsers and operating systems.

In the present invention, no application is required to be downloaded or installed by any user on any computer. Both individual leader or leaders and individual follower or followers do not need to install any application for the leader or leaders to drive the co-browsing session and for the follower or followers to view the web page in the iframe in the co-browsing session.

In one embodiment of the invention, systems and methods are provided for facilitating the collaborative co-browsing of a document or web page. The server retrieves a document (e.g., web pages) on behalf of a collaborating leader and distributes it to all followers for co-browsing, wherein the document is displayed in the iframe.

In one embodiment of the invention, systems and methods are provided for real-time chat or video chat over the internet, wherein the co-browsing session can be accomplished via a real-time chat or video chat vehicle and the web page can be displayed inside the iframe according to the URL.

### DETAILED DESCRIPTION OF THE DRAWINGS

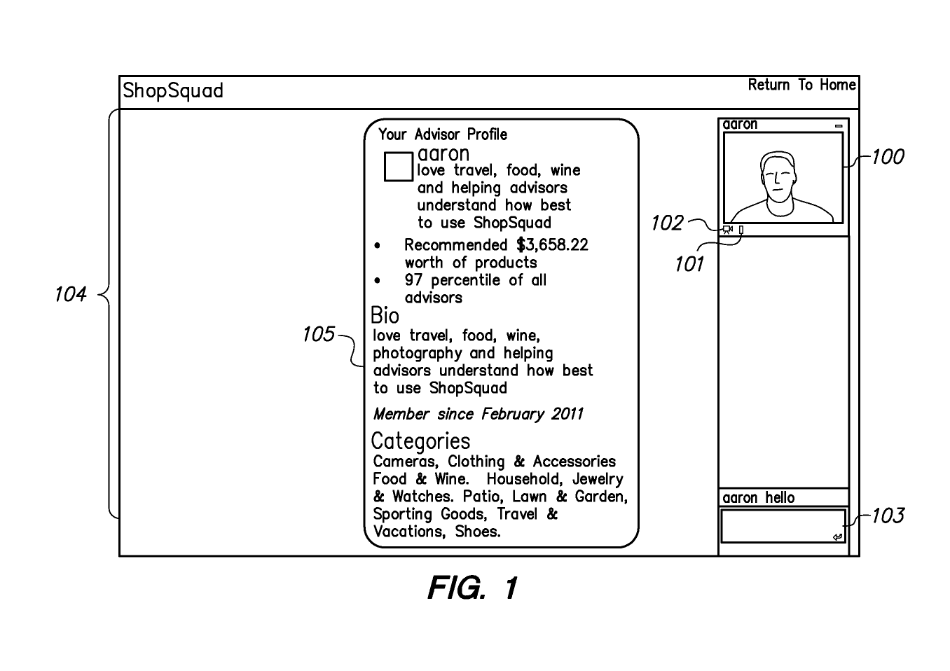

FIG. 1 illustrates the view of a user conducting a video chat, co-browsing session, wherein the users can turn on video chat 102 to see each other 100, voice chat 101, or message chat via typing in the input box 103. In conducting the chat session, the users will see an iframe 104, which is a frame within the original frame of the web browser where the leader can drive the co-browsing session to show the followers any web page. Within the iframe 104 is a quick profile 105 of the leader conducting the co-browsing session.

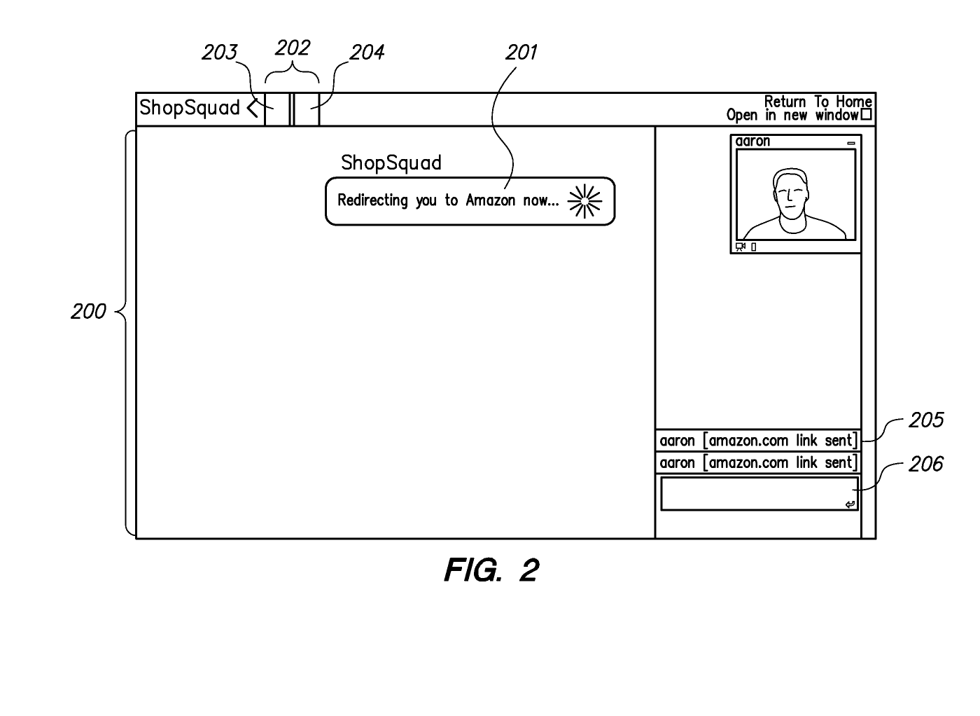

FIG. 2 illustrates the view of a user conducting video chat, co-browsing session, wherein the leader is directing a co-browsing session, wherein the iframe 200 is in the transition period from one web page to the new web page directed by the leader as indicated by the message 201 within the iframe 200. Furthermore, the users can see atop the iframe 200 that there is a catalog 202 comprising of icons 203, 204 showing previously viewed web pages. The co-browsing session is being directed via chat 205 at the chat window 206.

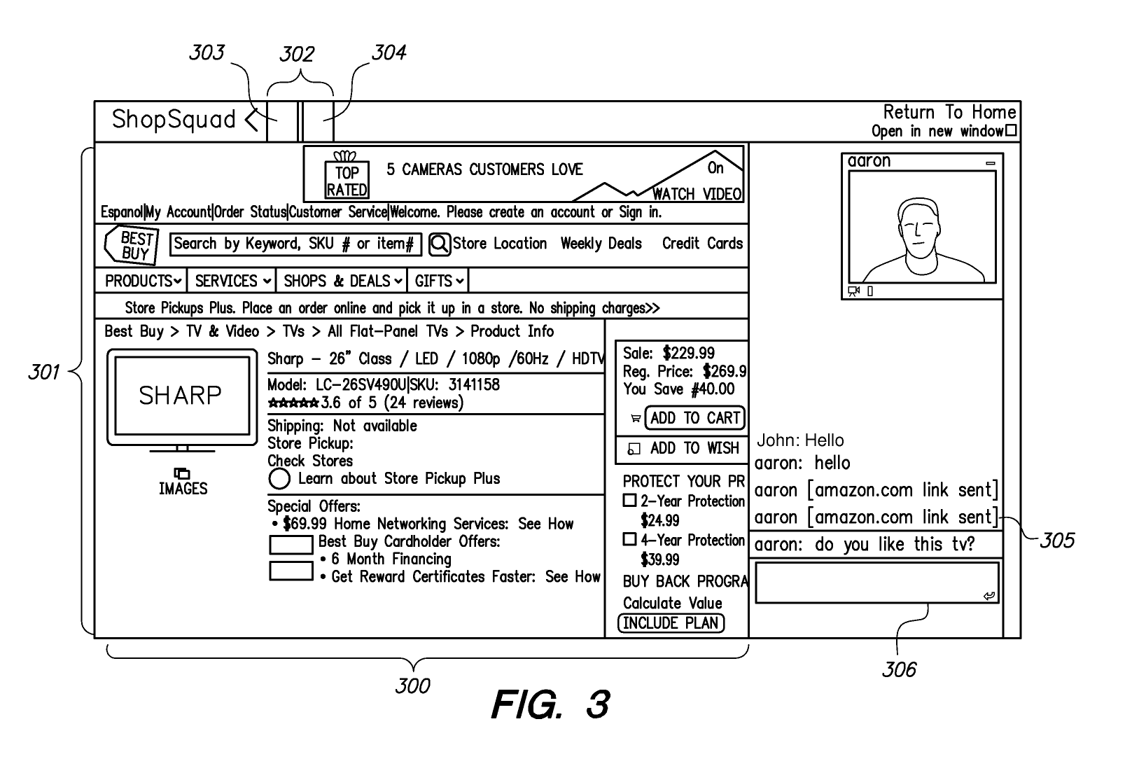

FIG. 3 illustrates another view of a user conducting video chat, co-browsing session, wherein the leader has directed the co-browsing session and drove the followers to a desired web page 300 as displayed inside the iframe 301. Again, the catalog 302 atop the iframe 301 shows the icons 303, 304 of the previously visited web pages and the current web page 300. The co-browsing session is being directed via chat 305 at the chat window 306.

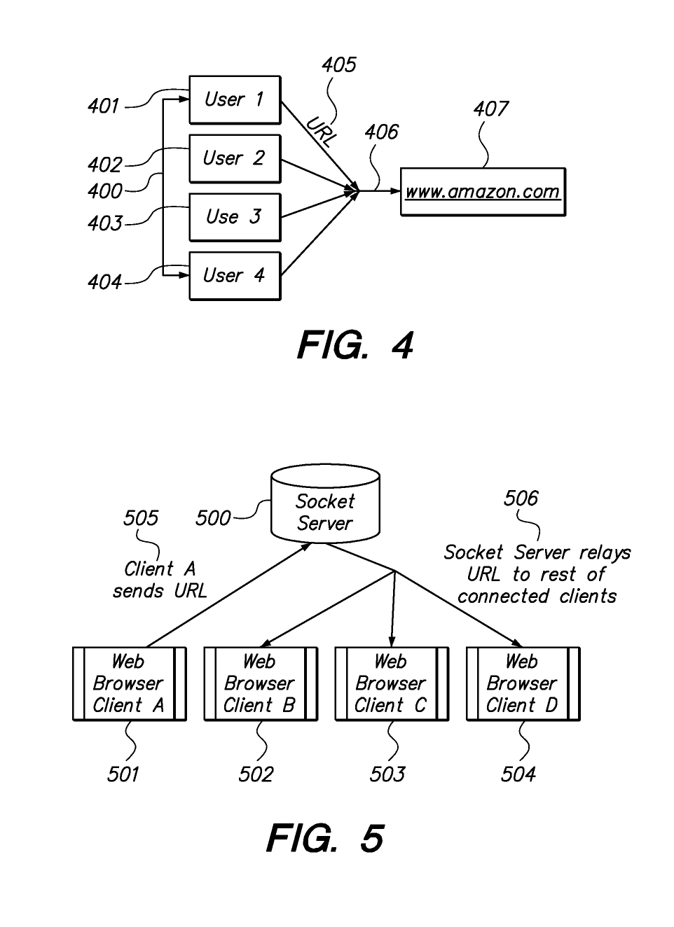

FIG. 4 illustrates a schematic diagram of the co-browsing session 400 with multiple users 401, 402, 403, 404, wherein User 1 401 is the leader and is driving the co-browsing session. As User 1 401 inputs the desired URL link 405 into the system, the iframe within the followers' browsers are directed to the desired web page 407 as directed by the leader 401. Neither the leader, User 1 401, nor the followers, User 2 402, User 3 403, and User 4 404, needs to install any application for the co-browsing session 400 to function, as the co-browsing session functions with across multiple platforms of browsers and operating systems.

FIG. 5 illustrates a schematic diagram of the co-browsing session interaction between the web browser clients 501, 502, 503, 504 and the server 500, wherein the Client A via web browser 501 sends URL 505 to the server 500 and the server relays the URL 506 to the rest of the connected clients 502, 503, 504. Upon the completion of the relay 506 by the server 500, the new page is displayed by the clients' web browsers 502, 503, 504.

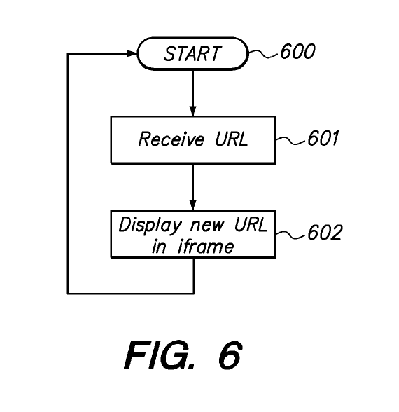

FIG. 6 illustrates a schematic diagram of the process of follower's iframe displaying the new page, wherein the follower opens up a web browser with iframe 600, the leader sends and the follower receives URL 601, and the iframe displays the new page 602 according to the URL 601 sent by the leader.

1. A method to facilitate user to user internet co-browsing comprising:
a. providing a network;
b. provide a host computer wherein said host computer is connected to said network;
c. having a first user connected to said network via a first web browser;
d. having a second user connected to said network via a second web browser;
e. said host computer is connected to said network;
f. said host computer connects said first user to said user two
g. wherein said first user inputs a web URL to said host computer;
h. said host computer automatically changes said second browser's web URL thereby causing said second user to view the content of said web URL.

2. The method of claim 1 wherein said first user inputs said web URL to said host computer via a message chat provided by said host computer.

3. The method of claim 1 wherein said first user inputs said web URL to said host computer via a message chat bar within a video chat provided by said host computer.

4. The method of claim 1 wherein said first user inputs said web url to said host computer by having said first user to select a web url from a list of web urls provided by said host computer.

5. The method of claim 4 wherein said host computer provides said list of web urls in response to said first user's request.

6. The method of claim 1 wherein said host computer automatically changes a sub-frame of said second browser's web URL thereby causing said second user to view the content of said web URL.

7. The method of claim 1 wherein said second user is able to input said web URL to said host computer wherein said host computer automatically changes said first browser's web URL thereby causing said first user to view the content of said web URL.

8. The method of claim 7 wherein said host computer automatically changes a sub-frame of said first browser's web URL thereby causing said first user to view the content of said web URL.

9. The method of claim 1 wherein said host computer displays in said first browser and said second browser previously displayed web URLs.

10. The method of claim 1 wherein said host computer displays in a sub-frame of said first browser and in a sub-frame of said second browser previously displayed web URLs.

11. The system to facilitate an user to user internet co-browsing comprising:
a. a network;
b. a host computer wherein said host computer is connected to said network;
c. a first user connected to said network via a first web browser;
d. a second user connected to said network via a second web browser;
e. said host computer is connected to said network;
f. said host computer connects said first user to said second user;
g. wherein said first user inputs a web URL to said host computer;
h. said host computer automatically changes said second browser's web URL thereby causing said second user to view the content of said web URL.

12. The system of claim 11 wherein said first user inputs said web URL to said host computer via a message chat provided by said host computer.

13. The method of claim 11 wherein said first user inputs said web URL to said host computer via a message chat bar within a video chat provided by said host computer.

14. The method of claim 11 wherein said first user inputs said web url to said host computer by having said first user to select a web url from a list of web urls provided by said host computer.

15. The method of claim 14 wherein said host computer provides said list of web urls in response to said first user's request.

16. The system of claim 11 wherein said host computer automatically changes a sub-frame of said second browser's web URL thereby causing said second user to view the content of said web URL.

17. The system of claim 11 wherein said second user is able to input said web URL to said host computer wherein said host computer automatically changes said first browser's web URL thereby causing said first user to view the content of said web URL.

18. The system of claim 17 wherein said host computer automatically changes a sub-frame of said first browser's web URL thereby causing said first user to view the content of said web URL.

19. The system of claim 11 wherein said host computer displays in said first browser and said second browser previously displayed web URLs.

20. The system of claim 11 wherein said host computer displays in a sub-frame of said first browser and in a sub-frame of said second browser previously displayed web URLs.
